(19) United States
(12) Patent Application Publication
(10) Pub. No.: US 2004/0258828 A1
(43) Pub. Date: Dec. 23, 2004

(54) Method for producing high vitamin butter oil

(76) Inventor: David Wetzel, Page, NE (US)

Correspondence Address: Law Offices of Adam H. Jacobs, Suite 726, 1904 Farnam Street, Omaha, NE, 68102, US

(21) Appl. No.: 10/464,150

(22) Filed: Jun. 18, 2003

(51) Int. Cl. A23D 7/00

(52) U.S. Cl. 426/601

(57) ABSTRACT

A method for producing high vitamin butter oil includes the steps of providing a quantity of cow's milk and separating the cream in the cow's milk from the skim in the cow's milk. The cream is then churned into butter and the butter is removed from the buttermilk remaining in the cream. The butter is then placed in a cooking container and cooked at a temperature below 150° F. until a majority of the butter separates into clarified butter containing high vitamin butter oil and butter wax adjacent the top of the cooking container and butter solids adjacent the base of the cooking container. The clarified butter is removed from the cooking container and allowed to stand, and then the high vitamin butter oil is separated from the butter wax by a centrifuge or the like. The high vitamin butter oil is then ready for use as a dietary supplement.

### BACKGROUND OF THE INVENTION

1. Technical Field

The present invention is directed to methods of production for dairy products and, more particularly, to a method for producing high vitamin butter oil which involves the steps of separating the cream in the cow's milk from the skim, churning the cream into butter, removing the butter from the buttermilk remaining in the cream, placing the butter in a cooking container and cooking the butter at a temperature below 150° Fahrenheit until the majority of the butter has separated into clarified butter and butter wax, removing the clarified butter from the cooking container and allowing it to stand for a predetermined length of time, and separating the lipid or high vitamin butter oil from the butter wax via a centrifuge or the like. The high vitamin butter oil is then ready for use as a dietary supplement or for any other particular desired purpose.

2. Description of the Prior Art

Cow's milk is a source for many different products, including cream, butter, milk, and many other substances which are beneficial for humans to consume. There are many different methods by which the various products produced from cow's milk are extracted from the cow's milk, many of which are well known in the art of dairy product production and in fact have been around for many hundreds if not thousands of years. However, further research and development in connection with the many potential products derived from cow's milk continue to produce valuable insights into the nutritional benefits of these various products.

Investigation of the various oils and solids of cow's milk have led to the discovery of many benefits when these oils and solids are taken as dietary supplements. For example, discussions of the various health benefits which may be gained by ingestion of cow's milk elements can be found in various written and electronically published documents which do not bear repeating in this document. However, it should be noted that many of the commonly obtainable cow's milk elements are well known and the methods for their extraction are commonly used. It is to be expected that additional elements in cow's milk will be found which provide additional health benefits not currently recognized in the dairy industry.

Among the various elements derived from cow's milk, there is one in particular which was known at one time, but has since become generally ignored and/or forgotten. Specifically, this product is referred to as high vitamin butter oil, and it was first discovered and used by a Dr. Weston A. Price back in the 1930s. Various writings on the subject of high vitamin butter oil are found in venerable magazines and books, and the benefits of the high vitamin butter oil are extolled by Dr. Price in his writings of all those years ago. However, it is unclear and has been unclear how the high vitamin butter oil is derived from cow's milk in order to utilize it as a dietary supplement, excepting a few vague references and writings by Dr. Price himself which do not provide specific details of the derivation process.

The reasons for the use of high vitamin butter oil as a dietary supplement are that it is extremely rich in vitamins A and D, E and a vitamin-like activator which is referred to as “Activator X”. The high vitamin butter oil further includes many essential fatty acids including conjugated linoleic acid (CLA) isomer 9-11, through over two hundred studies worldwide, has been found to have a high likelihood of helping to reduce the incidence of breast cancer, improve asthma, allergy control, and blood sugar control, and further may act to limit the extent of atherosclerosis, which can lead to heart disease. Therefore, there is a need for a method by which high vitamin butter oil may be extracted from cow's milk in order to obtain the benefits of using high vitamin butter oil as a dietary supplement.

At the present time, high vitamin butter oil is produced by cows eating an exclusive diet from pastures made up predominately of legumes, cool season grasses, and annual small grains all grazed predominately at a specific growth stage termed three to four-leaf and prior to budding. It has been found that this provides the proper bacterial function in the rumen of the animal for the ensuing fatty acid complex found in the butter oil. However, as was discussed previously, knowing that the high vitamin butter oil is there and actually being able to extract it from the milk are two separate things and therefore there is still a need for a method which will extract high vitamin butter oil from cow's milk in order to permit the use of the high vitamin butter oil as a dietary supplement to pass the benefits of the high vitamin butter oil on to persons ingesting the dietary supplement.

Therefore, an object of the present invention is to provide a method for extracting high vitamin butter oil from cow's milk.

Another object of the present invention is to provide a method for extracting high vitamin butter oil from cow's milk which includes the steps of separating the cream in the cow's milk from the skim in the cow's milk, churning the cream into butter, removing the butter from the buttermilk remaining in the cream, placing the butter in a cooking container and cooking it at a temperature below 150° Fahrenheit until a majority of the butter separates into clarified butter containing the high vitamin butter oil and butter wax at the top of the container and butter solids adjacent the base of the cooking container, removing the clarified butter from the cooking container and letting it stand, and then separating the high vitamin butter oil from the butter wax in the clarified butter via a centrifuge or the like to obtain the high vitamin butter oil.

Another object of the present invention is to provide a method for producing high vitamin butter oil from cow's milk which keeps the product in “raw” form, thus giving the product integrity in the marketplace and keeping in undamaged form any nutrients that may be adversely affected by heat.

Another object of the present invention is to provide a method for producing high vitamin butter oil from cow's milk which will not degrade or destroy the high vitamin butter oil during the extraction process.

Finally, an object of the present invention is to provide a method for producing high vitamin butter oil which is relatively simple, safe, and effective in use.

### SUMMARY OF THE INVENTION

The present invention provides a method for producing high vitamin butter oil which includes the steps of providing a quantity of cow's milk and separating the cream in the cow's milk from the skim in the cow's milk by use of a cream separator. The cream is then removed and churned into butter, and the butter is removed from the buttermilk remaining in the cream. The removed butter is placed in a cooking container and is cooked at a temperature below 150° Fahrenheit until a majority of the butter separates into two parts, the first being butter solids adjacent the base of the cooking container and the second being a clarified butter containing the high vitamin butter oil and butter wax which is adjacent the top of the cooking container. The clarified butter is then removed from the cooking container and is allowed to stand for a predetermined length of time in order to further separate the high vitamin butter oil from the butter wax. Finally, the high vitamin butter oil is separated from the butter wax by a centrifuge or via a decanting process in order to obtain the high vitamin butter oil which may then be used as a dietary supplement.

As thus described, the present method provides a relatively simple and straightforward method for producing high vitamin butter oil from cow's milk. Because the butter is cooked at a temperature below 150° Fahrenheit, the valuable nutrients within the butter remain undamaged, as is not the case when a product is pasturized, and thus the beneficial aspects of the high vitamin butter oil remain intact. Furthermore, the separation of the high vitamin butter oil from the butter wax via a centrifuge or the like provides a physical separation means for performing the separation which preserves the natural aspects of the high vitamin butter oil and further preserves the beneficial vitamins and acids within the high vitamin butter oil which might otherwise be lost if a chemical or temperature separation technique were to be used. Finally, the high vitamin butter oil produced by the present process is extremely pure and may be used as a dietary supplement without further processing, thus preserving the natural characteristics of the high vitamin butter oil. It is therefore seen that the present invention provides a substantial improvement over those methods found in the prior art.

### DESCRIPTION OF THE PREFERRED EMBODIMENT

The method of the present invention is described as follows. An initial quantity of cow's milk is obtained from the cow and is soon thereafter separated into cream and skim via a cream separator of the type commonly found in dairy product manufacturing plants the world over. Once the cream has been separated from the skim, it is gathered and put into a butter churning device where the cream is churned until it is turned into butter. Of course, the churning process does not turn all of the cream into butter, but rather only a part thereof, and it is the resulting butter product which is removed from the remaining buttermilk portion of the cream for further processing. It should be noted that during each step of the process of the present invention, the other elements of the cow's milk which are not used for further processing in the method of the present invention would be used for various purposes and to derive various products therefrom as would ordinarily be done in a dairy product manufacturing situation, thus preventing unnecessary waste of the byproducts of the present process.

The butter which has been removed from the cream is then placed into a cooking container, preferably a low-heat input cooking vat. The butter shall be cooked at a temperature below 150° Fahrenheit, but it should be noted that the temperature of 150° Fahrenheit is actually far in excess of the preferred and desired temperature range for the cooking process. In fact, it is preferred that the temperature of the cooking vat, in order to maintain the “raw” aspect of the product, be below 115° Fahrenheit and preferably even lower than that. It has been found through experimentation that the desired cooking temperature should be between 90° and 100° Fahrenheit, although, as it was stated previously, the temperature range is not overly critical so long as the “raw” aspect of the butter is maintained by keeping the temperature below 150° Fahrenheit. During the cooking process, the butter will separate into clarified butter on the top of the vat and milk solids will fall to the bottom of the vat. It has been found through experimentation that the cooking time for the butter will be approximately ten to thirty hours depending on the volume of the cooking vat and the nature of the butter product being cooked therein.

After the butter has been cooked to separate the butter into clarified butter and milk solids, the clarified butter is removed and is allowed to stand for approximately twenty-four hours at room temperature (approximately 70° Fahrenheit). The specific length of time which the clarified butter is allowed to stand is only critical in that the oils and waxes within the clarified butter should be allowed to settle and separate to enhance the future separation process to be applied to the clarified butter. Therefore, it should be noted that the length of time may be very short in the case of some types of clarified butter and may be extended in other situations, depending on the degree of separation desired and specific characteristics of the clarified butter being allowed to stand.

After the clarified butter has been allowed to stand for the predetermined length of time, the product is then separated by use of a centrifuge or the like which will separate the lipid high vitamin butter oil from the butter wax. It should be noted that the high vitamin butter oil is lipid at approximately room temperature (approximately 70° Fahrenheit) and thus the separation process using a centrifuge will occur relatively quickly. For example, it has been found via experimentation that centrifuging an amount of product for approximately two minutes at 1,500 g will properly separate the lipid high vitamin butter oil from the butter wax.

Of course, although the use of the centrifuge is preferred, other types of separating processes may be used to separate the high vitamin butter oil from the butter wax. For example, a decanting process may perform the separation task quite nicely, as would several other separating machines which utilize variations of the centrifuge process to separate liquids and solids of various densities from one another.

Once the separation process is complete, the lipid high vitamin butter oil is removed and it is then available for use as the high vitamin butter oil. The high vitamin butter oil may then be packaged in various forms, including paste, capsule, or any other format for distribution as a dietary supplement. As was stated previously, however, it is not the high vitamin butter oil itself which is unique in the present invention, but rather the method for extracting the high vitamin butter oil from the cow's milk which heretofore has been unknown.

It is to be understood that numerous modifications, additions and substitutions may be made to the method for extracting high vitamin butter oil from cow's milk of the present invention which fall within the intended broad scope of the appended claims. For example, the precise temperatures at which the butter is cooked during the cooking stage of the process may be modified or changed so long as the “raw” aspects of the butter are maintained. Furthermore, the precise method by which the separation of the lipid high vitamin butter oil from the butter wax in the clarified butter is performed is not critical to the present invention so long as the separation of the elements is properly performed. Finally, variations in the specific steps of the present method may be made in order to accommodate improvements or changes in various methods and devices used in and/or developed for the dairy product processing industry.

There has therefore been shown and described a method for extracting high vitamin butter oil from cow's milk which accomplishes at least all of its intended objectives.

I claim:

1. A method for producing high vitamin butter oil comprising the steps:
providing a quantity of cow's milk;
separating the cream in said cow's milk from the skim in said cow's milk;
churning said cream into butter;
removing said butter from buttermilk remaining in said cream;
placing said butter in a cooking container;
cooking said butter in said cooking container at a temperature below 150° F. until a majority of said butter separates into clarified butter containing high vitamin butter oil and butter wax adjacent the top of said cooking container and butter solids adjacent the base of said cooking container;
removing said clarified butter from said cooking container and letting said clarified butter stand for a predetermined length of time;
separating said high vitamin butter oil from said butter wax; and
transferring said high vitamin butter oil to a containment means for distribution thereof.

2. The method of claim 1 in which the step of separating said high vitamin butter oil from said butter wax comprises using a centrifuge to separate said high vitamin butter oil from said butter wax.

3. The method of claim 1 in which the step of cooking said butter in said cooking container further comprises cooking said butter at a temperature between 90° and 100° Fahrenheit for a period of time between ten (10) and thirty (30) hours.

4. The method of claim 2 in which the step of separating said high vitamin butter oil from said butter wax using a centrifuge to separate said high vitamin butter oil from said butter wax further comprises performing said separation at a temperature between 60° F. and 80° F.

5. A method for producing high vitamin butter oil comprising the steps:
providing a quantity of cow's milk;
separating the cream in said cow's milk from the skim in said cow's milk;
churning said cream into butter;
removing said butter from buttermilk remaining in said cream;
placing said butter in a cooking container;
cooking said butter in said cooking container at a temperature below 115° F. until a majority of said butter separates into clarified butter containing high vitamin butter oil and butter wax adjacent the top of said cooking container and butter solids adjacent the base of said cooking container;
removing said clarified butter from said cooking container and letting said clarified butter stand for a predetermined length of time;
separating said high vitamin butter oil from said butter wax via a centrifuge device; and
transferring said high vitamin butter oil to a containment means for distribution thereof.

6. The method of claim 5 in which the step of cooking said butter in said cooking container further comprises cooking said butter at a temperature between 90° and 100° Fahrenheit for a period of time between ten (10) and thirty (30) hours.
